(19) United States
(12) Patent Application Publication
(10) Pub. No.: US 2006/0273725 A1
(43) Pub. Date: Dec. 7, 2006

(54) Electric lamp and method of depositing a layer on the lamp

(75) Inventors: Georg Henninger, Aachen (NL); Wolfgang Doetter, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/572,472

(22) PCT Filed: Sep. 15, 2004
(86) PCT No.: PCT/IB04/51763

§ 371 Date: Mar. 20, 2006

(30) Foreign Application Priority Data
Sep. 23, 2003 (EP) 03103510.8

(51) Int. Cl. H01J 61/35; H01J 17/16

(52) U.S. Cl. 313/635

(57) ABSTRACT

An electric lamp has a light-transmitting lamp vessel (1) with a curved vessel portion (11) accommodating an elongated light source (2). Part of the curved vessel portion is provided with an optical interference film (5) of which the thickness differs locally. The interference film is thicker at locations on the curved vessel portion substantially parallel to the source axis as compared to other locations on the curved vessel portion. A method of depositing a layer of a material on a such an electric lamp, includes the steps of: moving the lamp vessel past sources of deposition material while simultaneously rotating the lamp vessel along its vessel axis, locally shielding the lamp vessel to locally reduce the thickness of the deposited material on the lamp vessel, the shielding means being provided in the vicinity of the lamp vessel and rotating at substantially the same speed as the lamp vessel.

The invention relates to an electric lamp comprising an interference film.

The invention further relates to a method of depositing a layer of a material on the electric lamp.

Such electric lamps are in particular incandescent lamps with an incandescent light source. In addition, the electric lamps may also be discharge lamps where, in operation, the arc discharge functions as the light source. Such electric lamps are used, for instance, in automotive applications, for example as a (halogen or discharge) headlamp, in operation emitting yellow light as an amber-colored light source in indicator lamps (also referred to as “vehicle signal lamps”) or as a red-colored light source in brake lights. Such electric lamps are also used for general illumination purposes. Said electric lamps are further used in traffic and direction signs, contour illumination, traffic lights, projection illumination and fiber-optics illumination. Alternative embodiments of such electric lamps comprise lamps wherein the color temperature is changed and/or infrared radiation is contained in the lamp vessel by means of suitable interference films.

The interference films reflect and/or allow passage of radiation originating from different parts of the electromagnetic spectrum, for example ultraviolet, visible and/or infrared light. Such interference films are customarily provided as a coating on (the lamp vessel of) electric lamps and/or on reflectors.

Generally, two types of lamp vessels are employed. One type of electric lamps comprises the so-called “double-ended” lamp vessel having first and second end portions arranged opposite each other. In double-ended lamps respective current-supply conductors electrically connected to the light source issue from the lamp vessel via the first and second end portion. The other type of electric lamps comprises the so-called “single-ended” lamp having only a single end portion. In single-ended lamps, current-supply conductors electrically connected to the light source issue from the lamp vessel via the end portion.

The deposition of materials to form coatings on curved substrates is well known and is used, for example, in the manufacture of lamps. In the manufacture of lamps, particularly lamps which include a hermetically-sealed light-emitting lamp vessel in which a light source is arranged (i.e., a lamp burner), it is often desirable to deposit one or more materials to form a coating on at least a portion of the surface of the lamp burner. For example, it is well known to deposit materials on the surface of the lamp vessel to form infrared reflecting, ultraviolet reflecting, heat reflecting material, and visible spectrum radiation reflecting interference films.

The interference film may be provided in a customary manner by means of, for example, vapor deposition (PVD: physical vapor deposition) or by (ac or dc) (reactive) sputtering or by means of a dip-coating or spraying process or by means of LP-CVD (low-pressure chemical vapor deposition), PE-CVD (plasma-enhanced CVD) or PI-CVD (plasma impulse chemical vapor deposition).

An electric lamp of the type mentioned in the opening paragraph is known from EP-A 0 986 083. The known electric lamp has an interference filter coating with local thickness differences to ensure identical color composition emission at all points. The known electric lamp includes an incandescent lamp with a pear-shaped lamp vessel and with an interference filter coating having a thickness along the shortest line on the vessel connecting the intersection of the rotational symmetry axis and the lamp vessel with a point on the tapering vessel region, which thickness increases steadily from a minimal value to a maximum value at the line end point at this tapering vessel region.

In designing the interference films on the known lamp it is assumed that the light source is a point source. This is a drawback of the known electric lamp.

The invention has for its object to provide an electric lamp wherein said drawback is obviated. According to the invention, an electric lamp of the kind mentioned in the opening paragraph for this purpose comprises:

a light-emitting lamp vessel comprising a curved vessel portion,

an elongated light source with a longitudinal source axis being arranged in the curved vessel portion,

at least part of the curved vessel portion being provided with an optical interference film,

the interference film comprising a plurality of alternating high and low refractive index layers,

the thickness of the interference film on the curved vessel portion being locally different,

the interference film being thicker at locations on the curved vessel portion substantially parallel to the source axis as compared to other locations on the curved vessel portion.

Light emitted by the light source in the lamp vessel hits the curved vessel portion at a plurality of angles. The so-called “angle of incidence” of a light ray on a surface is normally measured with respect to the normal to that surface. The shape and geometry of the curved vessel portion taking into account of the extensiveness of the light source determine to a great extent what angles of incidence are to be expected at a certain point on the curved vessel portion. At locations on the curved vessel portion substantially parallel to the source axis, the variation in the angles of incidence is normally substantially larger than at other locations on the curved vessel portion. Variations in the distribution of angles of incidence have influence on the performance of the interference film. Generally speaking, if the angle of incidence of the light on a surface is close to 0° (also addressed as “normal incidence”), the interference film functions according to its designed thickness. If the angle of incidence increases (also addressed as “non-normal incidence”), the interference film appears to be thinner and the spectral characteristics of the interference film change. This may, by way of example, result in color effects, in a diminished infrared reflectance and/or in a shift of an edge wavelength of an interference film. Such effects are undesirable. In particular, the effects mentioned become paramount for angles of incidence larger than 20°.

The effect of the interference film “acting” thinner at non-normal incidence is most prominent at locations on the curved vessel portion that are substantially parallel to the source axis. By increasing, according to the invention, the thickness in particular at locations on the curved vessel portion that are substantially parallel to the source axis, the effects of non-normal incidence are counteracted effectively. In this manner, in the electric lamp according to the invention account is taken of the extensiveness of the light source in the curved vessel portion of the lamp vessel. Effects of the extensiveness of the light source are compensated for, in particular, at locations where the effects of non-normal incidence are more prominent than at other locations.

It is remarked that, in view of kinematic inversion, the interference film may also be made thinner at locations on the curved vessel portion that are relatively remote from locations on the curved vessel portion that are substantially parallel to the source axis while the overall thickness of the interference film is increased at other locations. The local thinning of the interference film may be accompanied by increasing the overall thickness of the interference film.

A preferred embodiment of the electric lamp in accordance with the invention is characterized in that the lamp vessel has an elongated shape with a longitudinal vessel axis, the vessel axis substantially coinciding with the source, the thickness of the interference film being locally thicker in the vicinity of locations on the curved vessel portion, where a plane substantially perpendicular to the source axis and comprising the geometrical center of the light source intersects the curved vessel portion. This preferred embodiment of the electric lamp particularly relates to so-called double-ended lamps. Such double-ended lamps are characterized in that the electric lamp has a first and a second end portion which are arranged opposite each other, respective current-supply conductors electrically connected to the light source issuing from the lamp vessel via the first and second end portions.

The geometry of double-ended lamps comprising a curved vessel portion in which an elongated light source is arranged is such that in the middle of the curved vessel portion the angle of incidence encompasses a larger range of angles than at location close to the end portions of the lamp where the angle of incidence is more confined to normal incidence. To compensate for the effects of non-normal incidence on the interference film due to this broader range of angles of incidence, the thickness of the interference film is made thicker near the curved vessel portion where a plane, substantially perpendicular to the source axis and comprising the geometrical center of the light source, intersects the curved vessel portion. In the case of double ended lamps, the interference film is made thicker in a band around the central part of the curved vessel portion as compared to the positions which are further away from this central band on the curved vessel portion.

Another preferred embodiment of the electric lamp in accordance with the invention is characterized in that the lamp vessel has an elongated shape with a longitudinal vessel axis, the vessel axis being substantially perpendicular to the source axis, the thickness of the interference film being locally thicker in the vicinity of locations on the curved vessel portion, where a line substantially perpendicular to the source axis and the vessel axis intersects the curved vessel portion. This preferred embodiment of the electric lamp particularly relates to so-called single-ended lamps. Such single-ended lamps are characterized in that the electric lamp has a single end portion, current-supply conductors electrically connected to the light source issuing from the lamp vessel via the end portion.

The geometry of single-ended lamps comprising a curved vessel portion in which an elongated light source is arranged is such that at certain locations on the curved vessel portion the light source is closer to the wall of the curved vessel portion than at locations substantially perpendicular to these locations. At locations on the curved vessel portion where the light source is closer to the wall of the curved vessel portion, the distribution of the angles of incidence is smaller than at locations on the curved vessel portion where the light source is relatively remote from the wall of the curved vessel portion. At these remote locations, the distribution of angles of incidence is relatively large, leading to undesired effects of the interference film acting thinner than according to the physical thickness of the interference film. By locally increasing the thickness of the interference film at the locations where the light source is relatively far removed from the wall of the curved vessel portion, the effects of non-normal incidence can be compensated for.

Preferably, the local thickness variation in the total thickness of the interference film is at least 3%.

The present invention also relates to a method of depositing a layer of a material on a substrate (lamp vessel) to form coatings and finds use in the manufacture of lamps wherein a coating is formed on at least a portion of the surface of the lamp burner. The method relates generally to the manufacture of lamps such as halogen lamps and discharge lamps. In these methods it is normally desirable that the materials deposited on the surface of the lamp vessel form a coating which possesses uniform physical characteristics throughout the coated surface around the circumference of the lamp vessel. In this way the physical characteristics of the coating on any one portion of the surface of the lamp vessel are the same as the physical characteristics of the coating on the other portions of the surface of the lamp burner. By rotating each lamp vessel around its longitudinal or vessel axis while depositing the material or materials on the selected portions of the surface of the lamp burner to form the coating, each portion of the circumference of the lamp burner material or materials deposited may be uniformly deposited around the circumference of each lamp burner, thereby providing uniformity in the physical characteristics of the coating about the entire coated surface of the lamp burner. It is an object of the present invention to provide a novel coating method for forming a uniform coating on an array of lamp vessel envelopes where the thickness of the interference film on pre-determined locations on the lamp vessel is locally different in a controlled manner. According to the invention, a method of the kind mentioned in the opening paragraph for this purpose includes the steps of:

moving the lamp vessel past one or more sources of deposition material while simultaneously rotating the lamp vessel along its vessel axis,

locally shielding the lamp vessel for locally reducing the thickness of the deposited material on the lamp vessel,

the shielding means being provided in the vicinity of the lamp vessel and rotating at substantially the same speed as the lamp vessel.

By rotating the shielding means at the same speed, the thickness of the interference film on the lamp vessel can be locally varied in a controlled way.

A preferred embodiment of the method in accordance with the invention is characterized in that the lamp vessel has an elongated shape with a longitudinal vessel axis, an elongated light source with a longitudinal source axis being arranged in the lamp vessel, the source axis being substantially perpendicular to the vessel axis, and in that the shielding means are arranged in the vicinity of locations on the vessel portion where the source axis intersects the curved vessel portion. Preferably, the electric lamp is a single-ended lamp with a single end portion, current-supply conductors electrically connected to the light source issuing from the lamp vessel via the end portion.

These and other aspects of the invention will be apparent from and elucidated with reference to the embodiment(s) described hereinafter.

In the drawings:

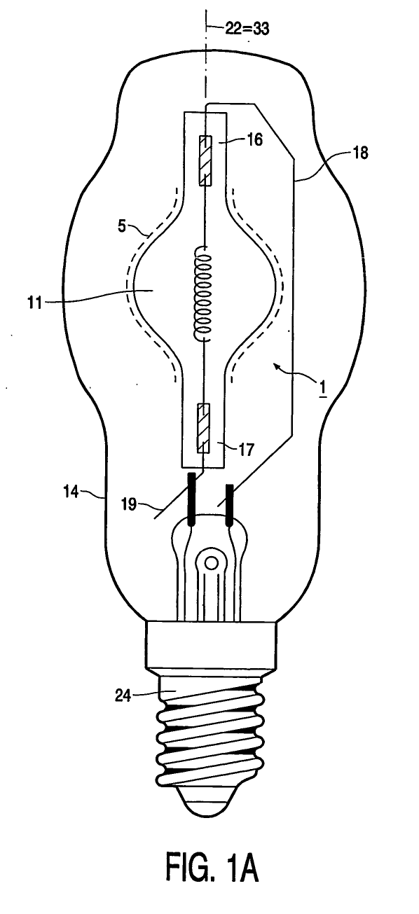

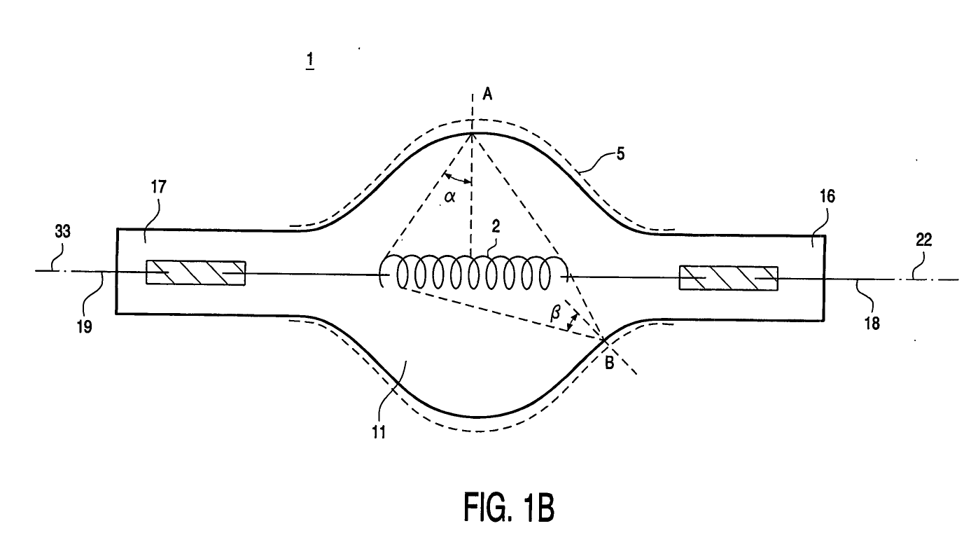

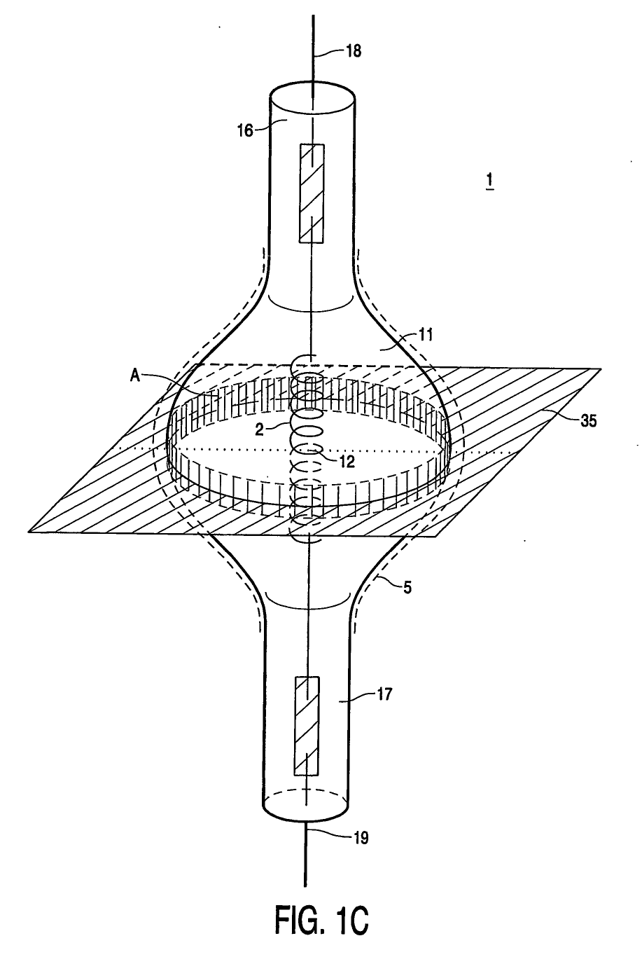

FIG. 1a is a side view of an embodiment of an electric lamp comprising a double-ended lamp vessel in accordance with the invention;

FIG. 1b is a cross-sectional view of the double-ended lamp vessel as shown in FIG. 1a;

FIG. 1c is a perspective view of the double-ended lamp vessel as shown in FIGS. 1a and 1b;

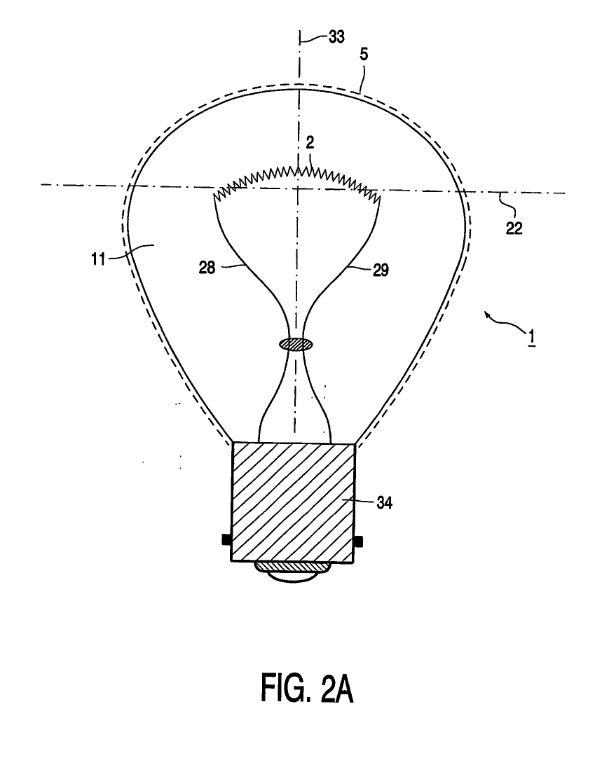

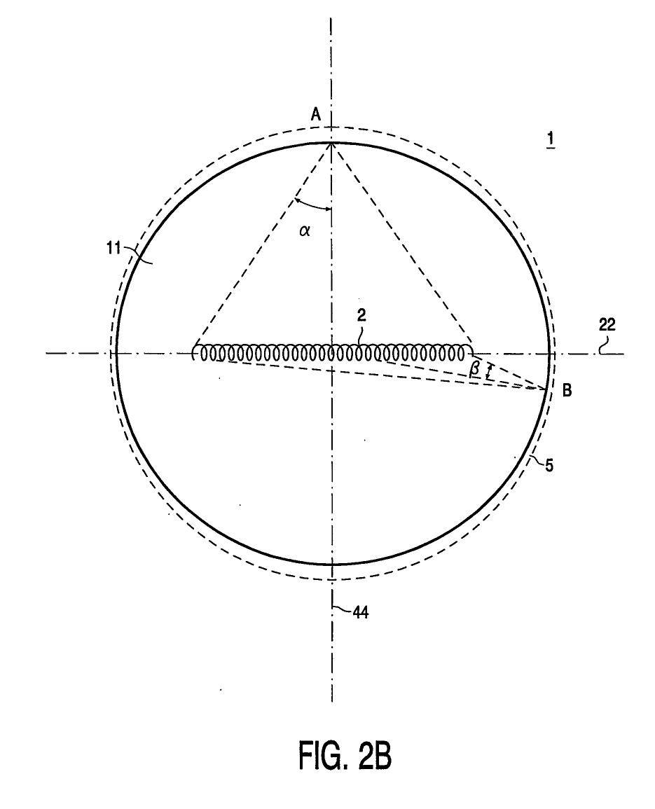

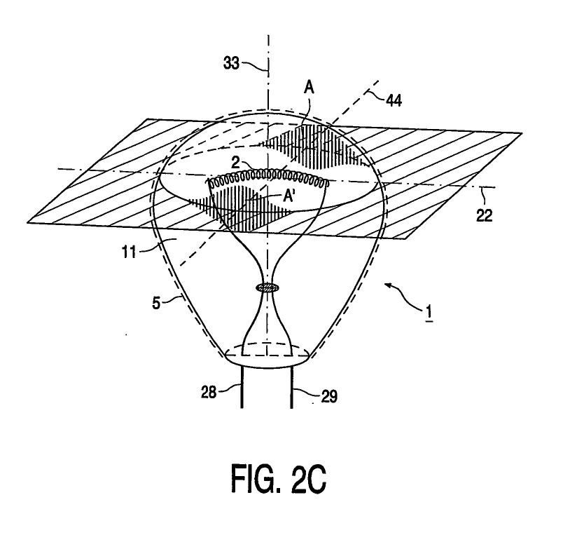

FIG. 2a is a side view of an embodiment of the electric lamp comprising a single-ended lamp vessel in accordance with the invention;

FIG. 2b is a cross-sectional view of the electric lamp as shown in FIG. 2a, showing a plane perpendicular to the vessel axis, the plane containing the light source;

FIG. 2c is a perspective view of the single-ended lamp vessel as shown in FIGS. 2a and 2b;

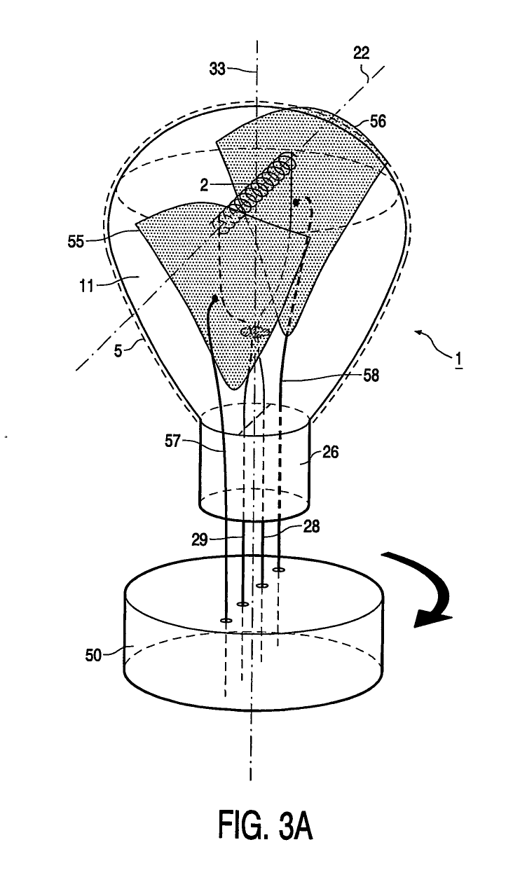

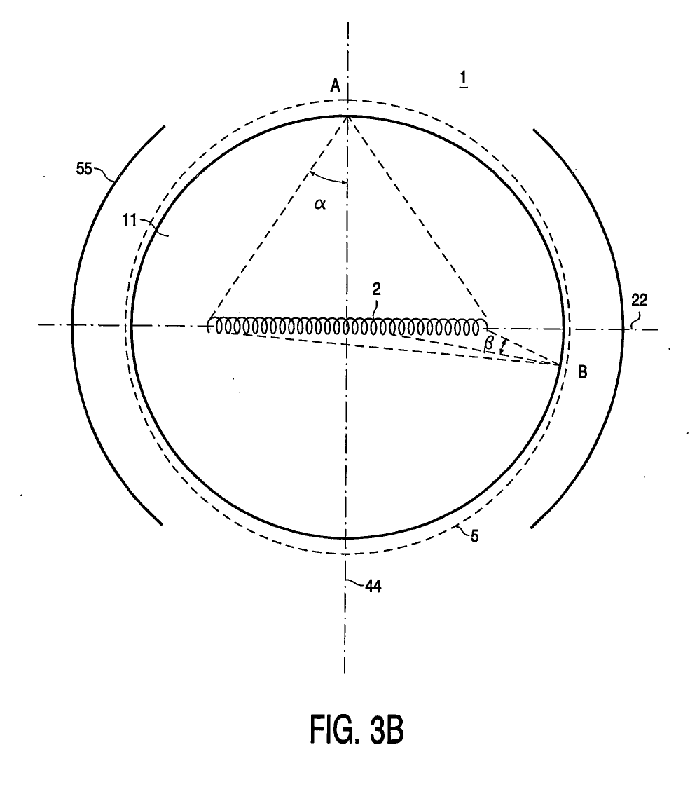

FIG. 3a is a perspective view of a single-ended lamp vessel during deposition of a layer material, and

FIG. 3b is a cross-sectional view of the electric lamp as shown in FIG. 3a, showing a plane perpendicular to the vessel axis, the plane containing the light source.

The FIGS. are purely schematic and not drawn to scale. Particularly for clarity, some dimensions are strongly exaggerated. In the Figures, like reference numerals refer to like parts whenever possible.

FIG. 1a is a side view of an embodiment of an electric lamp comprising a double-ended lamp vessel 1 in accordance with the invention. The lamp has a light-emitting lamp vessel 1, for example of quartz glass, comprising a curved vessel portion 11. The curved vessel portion 11 is sealed in a gastight manner and accommodates an elongated light source 2 with a longitudinal source axis 22. In the example of FIG. 1a, the light source 2 is a (spiral-shaped) tungsten incandescent body. In an alternative embodiment two electrodes are arranged in the lamp vessel between which, in operation, an arc discharge is maintained. The double-ended lamp vessel 1 shown in FIG. 1a has a first 16 and a second 17 end portion arranged at opposite sides of the curved vessel portion 11. Current-supply conductors 18, 19 electrically connected to the light source 2 issue from the lamp vessel 1 via the first and second end portions 16, 17. The lamp vessel 1 in FIG. 1a is mounted in an outer bulb 14, which is supported by a lamp cap 24 to which the current-supply conductors 18, 19 are electrically connected. In the example of FIG. 1a, the lamp vessel 1 has an elongated shape with a longitudinal vessel axis 33. In FIG. 1a the vessel axis 33 substantially coincides with the source axis 22.

At least part of the outer surface of the curved vessel portion 11 is provided with an optical interference film 5. The interference film 5 comprises a plurality of alternating high and low refractive index layers. Suitable layer materials having a comparatively high refractive index are for example titanium oxide (average refractive index of TiO₂ approximately 2.35-2.8 at 550 nm), niobium oxide (average refractive index of Nb₂O₅ approximately 2.35 at 550 nm), tantalum oxide (average refractive index of Ta₂O₅ approximately 2.18 at 550 nm) and zirconium oxide (average refractive index of ZrO₂ approximately 2.06 at 550 nm). A suitable layer material having a relatively low refractive index is silicon oxide (average refractive index approximately 1.46). For all materials mentioned, the refractive index may slightly differ in dependence on the deposition method employed.

The thickness of the interference film 5 on the curved vessel portion 11 differs locally. According to the invention, the interference film 5 is thicker at locations on the curved vessel portion 11 substantially parallel to the source axis 22 as compared to other locations on the curved vessel portion 11.

FIG. 1b schematically shows a cross-sectional view of the double-ended lamp vessel 1 as shown in FIG. 1b. Light emitted by the light source 2 in the lamp vessel 1 hits the curved vessel portion 11 at a plurality of angles. The shape and geometry of the curved vessel portion 11 in combination with the extensiveness of the light source 2 determine to a great extent what angles of incidence are to be expected at a certain point on the curved vessel portion 11. In FIG. 1b two distributions of angles of incidence are shown by the dashed lines inside the curved vessel portion 11 to exemplify the differences in effects of the interference film 5 at various locations on the curved vessel portion 11. At locations on the curved vessel portion 11 which are substantially parallel to the source axis 22 (indicated by the area “A” in FIG. 1b), the variation in the angles of incidence is normally substantially larger than at other locations on the curved vessel portion 11 (see for instance the location indicated by the area “B” in FIG. 1b). The angles of incidence are measured with respect to the normal to the surface of the curved vessel portion 11. In the example of FIG. 1b, at locations on the curved vessel portion 11 substantially parallel to the source axis (indicated by the area “A” in FIG. 1b), the angles of incidence a vary between +40° and −40°. On the other hand, at locations relatively remote from these locations, the angles of incidence β vary only between +10° and −30° (indicated by the area “B” in FIG. 1b). Variations in the distribution of angles of incidence have influence on the performance of the interference film. At normal incidence or close to normal incidence, the interference film “functions” according to its designed thickness. At non-normal incidence, in particular at angles greater than 20°, the interference film “appears” to be thinner and the spectral characteristics of the interference film change. This may particularly give rise to an unwanted shift of an edge wavelength of an interference film. According to the invention, this undesired effect of the extensiveness of the light source 2 can be compensated for by making the thickness of the interference film 5 locally thicker in the vicinity of locations substantially parallel to the source axis 22. By locally thickening the interference film 5, the performance of the interference film 5 is compensated for by variation in the angle of incidence. The average angle of incidence is somewhat larger at these locations and by making the filter coating somewhat thicker at these locations, the average performance of the interference film 5 is within acceptable boundaries.

FIG. 1c is a perspective view of the double-ended lamp vessel as shown in FIGS. 1a and 1b. In the drawing an interference film 5 is applied on the curved vessel portion 11 with local thickness variations. In order to compensate for the undesired effect of the relatively broad distribution of angles of incidence, the thickness of the interference film 5 is made locally thicker in the vicinity of locations (indicated with a relatively broad band “A” which is indicated with the vertical lines in FIG. 1c) on the curved vessel portion 11 where a plane 35, substantially perpendicular to the source axis 33 (coinciding with the source axis 22) and comprising the geometrical center 12 of the light source 2, intersects the curved vessel portion 11.

FIG. 2a schematically shows a side view of an embodiment of the electric lamp comprising a single-ended lamp vessel in accordance with the invention. The lamp has a light-emitting lamp vessel 1, for example of hard glass, comprising a curved vessel portion 11. In the example of FIG. 2a, the lamp vessel 1 has an elongated shape with a longitudinal vessel axis 33. The curved vessel portion 11 is sealed in a gastight manner and accommodates an elongated light source 2 with a longitudinal source axis 22. In the example of FIG. 2a, the light source 2 is not perfectly stretched along the source axis 22, the source axis being the average direction of the light source, preferably perpendicular to the vessel axis 33. In the example of FIG. 2a, the light source 2 is a (spiral-shaped) tungsten incandescent body. In an alternative embodiment two electrodes are arranged in the lamp vessel between which, in operation, an arc discharge is maintained. The single-ended lamp vessel 1 shown in FIG. 2a has a single end portion. Current-supply conductors 28; 29 electrically connected to the fight source 2 issue from the lamp vessel 1 via the end portion (see FIG. 3). The lamp vessel 1 in FIG. 2a is mounted on a lamp cap 34 (hiding the end portion) to which the current-supply conductors 28, 29 are electrically connected. In FIG. 2a the vessel axis 33 is substantially perpendicular to the source axis 22.

At least part of the outer surface of the curved vessel portion 11 is provided with an optical interference film 5. The interference film 5 comprises a plurality of alternating high and low refractive index layers. The thickness of the interference film 5 on the curved vessel portion 11 differs locally. According to the invention, the thickness of the interference film 5 is locally thicker in the vicinity of locations on the curved vessel portion 11 where a line 44 (see FIG. 2b) substantially perpendicular to the source axis 22 and the vessel axis 33 intersects the curved vessel portion 11.

FIG. 2b schematically shows a cross-sectional view of the single-ended lamp vessel 1 as shown in FIG. 2a. FIG. 2b shows a plane perpendicular to the vessel axis 33 and containing the light source 2. Light emitted by the light source 2 in the lamp vessel 1 hits the curved vessel portion 11 at a plurality of angles. The shape and geometry of the curved vessel portion 11 in combination with the extensiveness of the light source 2 determine to a great extent what angles of incidence are to be expected at a certain point on the curved vessel portion 11. In FIG. 2b two distributions of angles of incidence are shown by the dashed lines inside the curved vessel portion 11 to exemplify the differences in effects of the interference film 5 at various locations on the curved vessel portion 11. At locations on the curved vessel portion 11 which are substantially parallel to the source axis 22 (indicated by the area “A” in FIG. 2b), the variation in the angles of incidence is normally substantially larger than at other locations on the curved vessel portion 11 (see for instance the location indicated by the area “B” in FIG. 1b). The angles of incidence are measured with respect to the normal to the surface of the curved vessel portion 11. In the example of FIG. 2b, at locations on the curved vessel portion 11 substantially parallel to the source axis (indicated by the area “A” in FIG. 2b), the angles of incidence a vary between +40° and −40°. On the other hand, at locations relatively remote from these locations, the angles of incidence P vary only between +5° and −15° (indicated by the area “B” in FIG. 2b). Variations in the distribution of angles of incidence have influence on the performance of the interference film. At normal incidence or close to normal incidence, the interference film “functions” according to its designed thickness. At non-normal incidence, in particular at angles greater than 20°, the interference film “appears” to be thinner and the spectral characteristics of the interference film change. This, may particularly give rise to an unwanted shift of an edge wavelength of an interference film. According to the invention, this undesired effect of the extensiveness of the light source 2 can be compensated for by making the thickness of the interference film 5 locally thicker in the vicinity of locations substantially parallel to the source axis 22. By locally thickening the interference film 5, the performance of the interference film 5 is compensated for by variation in the angle of incidence. The average angle of incidence is somewhat larger at these locations and by making the filter coating somewhat thicker at these locations, the average performance of the interference film 5 is within acceptable boundaries.

FIG. 2c is a perspective view of the double-ended lamp vessel as shown in FIGS. 2a and 2b. In the drawing an interference film 5 is applied on the curved vessel portion 11 with local thickness variations. In order to compensate for the undesired effect of the relatively broad distribution of angles of incidence, the thickness of the interference film 5 is locally thicker in the vicinity of locations on the curved vessel portion 11 where a line 44, substantially perpendicular to the source axis 22 and the vessel axis 33, intersects the curved vessel portion 11. These areas are indicated by the vertical lines covering the relatively extensive large areas A and A′ in FIG. 2c.

It is often desirable to prevent the deposition of the coating materials on selected portions of the surface to be coated. This may be achieved by masking the selected portions, for instance, by providing a physical barrier to prevent the deposition of the coating material on the selected portions. To this end, the invention has for its object to provide a method of depositing a layer of a material on the electric lamp, the electric lamp comprising an elongated lamp vessel with a longitudinal vessel axis. According to the invention, a method of the kind mentioned in the opening paragraph for this purpose includes the steps of moving the lamp vessel past one or more sources of deposition material while simultaneously rotating the lamp vessel along its vessel axis, locally shielding the lamp vessel for locally reducing the thickness of the deposited material on the lamp vessel. The shielding means is provided in the vicinity of the lamp vessel and rotates at substantially the same speed as the lamp vessel. By rotating the shielding means at the same speed, the thickness of the interference film on the lamp vessel can be locally varied in a controlled way.

FIG. 3a schematically shows a perspective view of a single-ended lamp vessel during deposition of a layer material. The lamp vessel 1 has an elongated shape with an end portion 26. Current-supply conductors 28; 29 electrically connected to the fight source 2 issue from the lamp vessel 1 via the end portion 26. The lamp vessel 1 has a longitudinal vessel axis 33. An elongated light source 2 with a longitudinal source axis 22 is arranged in the lamp vessel 1. In the example of FIG. 3a, the source axis 22 is substantially perpendicular to the vessel axis 33.

During deposition of the layer material, shielding means 55; 56 are arranged in the vicinity of locations on the vessel portion 11 where the source axis 22 intersects the curved vessel portion 11. In the example of FIG. 3a, the shielding means 55; 56 are arranged in the vicinity of the outer surface of the lamp vessel 1 adjacent to the end portions of the elongated light source 2. The lamp vessel 1 via the current-supply conductors 28; 29 and the shielding means 55; 56 via carrying means 57; 58 are mounted on a substrate carrier 50. During deposition of the layer material on the electric lamp, the lamp vessel and the shielding means 55; 56 rotate at the same speed. The shielding means 55; 56 provide that the interference film 5 adjacent to the end portions of the elongated light source 2 is locally thinner than at other locations on the lamp vessel. Because the distribution of angles of incidence (see FIG. 2b) is smaller at locations on the lamp vessel 1 where the source axis 22 intersects the lamp vessel 1, the interference film 5 is locally thinner at these locations. By correspondingly increasing the thickness of the interference film 5 the desired performance of the interference film is achieved.

FIG. 3b shows schematically a cross-sectional view of the electric lamp as shown in FIG. 3a, showing a plane perpendicular to the vessel axis, the plane containing the light source. The shielding means 55; 56 are arranged in the vicinity of the outer surface of the lamp vessel 1 adjacent to the end portions of the elongated light source 2. The interference film is locally thinner on places on the lamp vessel 1 adjacent to the shielding means 55; 56.

Preferably, the shielding means comprises a rod, a mesh, a plate and/or a ring. Any combination of shielding means may be provided. Preferably, the material is deposited via a sputter deposition process to form an optical interference film.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electric lamp comprising:
a light-transmitting lamp vessel (1) comprising a curved vessel portion (11),
an elongated light source (2) with a longitudinal source axis (22) being arranged in the curved vessel portion (11),
at least part of the curved vessel portion (11) being provided with an optical interference film (5),
the interference film (5) comprising a plurality of alternating high and low refractive index layers,
the thickness of the interference film (5) on the curved vessel portion (11) being locally different,
the interference film (5) being thicker at locations on the curved vessel portion (11) substantially parallel to the source axis (22) as compared to other locations on the curved vessel portion (11).

2. An electric lamp as claimed in claim 1, characterized in that
the lamp vessel (1) has an elongated shape with a longitudinal vessel axis (33), the vessel axis (33) substantially coinciding with the source axis (22),
the thickness of the interference film (5) being locally thicker in the vicinity of locations on the curved vessel portion (11) where a plane (35), substantially perpendicular to the source axis (33) and comprising the geometrical center (12) of the light source (2), intersects the curved vessel portion (11).

3. An electric lamp as claimed in claim 2, characterized in that the electric lamp has a first (16) and a second (17) end portion which are arranged opposite each other, respective current-supply conductors (18; 19) electrically connected to the light source (2) issuing from the lamp vessel (1) via the first and second end portions (16, 17).

4. An electric lamp as claimed in claim 1, characterized in that
the lamp vessel (1) has an elongated shape with a longitudinal vessel axis (33), the vessel axis (33) being substantially perpendicular to the source axis (22),
the thickness of the interference film (5) being locally thicker in the vicinity of locations on the curved vessel portion (11) where a line (44), substantially perpendicular to the source axis (22) and the vessel axis (33), intersects the curved vessel portion (11).

5. An electric lamp as claimed in claim 4, characterized in that the electric lamp has a single end portion, current-supply conductors (28; 29) electrically connected to the light source (2) issuing from the lamp vessel (1) via the end portion.

6. An electric lamp as claimed in claim 1, characterized in that the local thickness variation in the total thickness of the interference film (5) is at least 3%.

7. An electric lamp as claimed in claim 1, characterized in that the light source (2) comprises at least one incandescent lamp body or an arc of a discharge lamp in operation.

8. A method of depositing a layer of a material on an electric lamp according to claim 1, the electric lamp comprising an elongated lamp vessel (1) with a longitudinal vessel axis (33), the method including the steps of:
moving the lamp vessel (1) past one or more sources of deposition material while simultaneously rotating the lamp vessel (1) along its vessel axis (33),
locally shielding the lamp vessel by shielding means (55, 56) for locally reducing the thickness of the deposited material on the lamp vessel (1),
the shielding means () being provided in the vicinity of the lamp vessel (1) and rotating at substantially the same speed as the lamp vessel (1).

9. A method as claimed in claim 8, characterized in that
the lamp vessel (1) has an elongated shape with a longitudinal vessel axis (33), an elongated light source (2) with a longitudinal source axis (22) being arranged in the lamp vessel (1), the source axis (22) being substantially perpendicular to the vessel axis (33), and
in that the shielding means (55; 56) is arranged in the vicinity of locations on the vessel portion (11) where the source axis (22) intersects the curved vessel portion (11).

10. A method as claimed in claim 9, characterized in that the electric lamp is a single-ended lamp with a single end portion (26), current-supply conductors (28; 29) electrically connected to the light source (2) issuing from the lamp vessel (1) via the end portion.

11. A method as claimed in claim 8, characterized in that the shielding means (55; 56) comprises a rod, a mesh, a plate and/or a ring.

12. A method as claimed in claim 8, characterized in that the material is deposited in a sputter deposition process to form an optical interference film (5).
